(19) United States
(12) Patent Application Publication
(10) Pub. No.: US 2015/0046217 A1
(43) Pub. Date: Feb. 12, 2015

(54) Computing Social Influenceability of Products and Social Influencers

(71) Applicant: International Business Machines Corporation, Armonk, NY (US)

(72) Inventors: Michael Desmond, White Plains, NY (US); Natwar Modani, Gurgaon (IN); Seema Nagar, Bangalore (IN); Harini Srinivasan, Tarrytown, NY (US); Roman Vaculin, Bronxville, NY (US)

(73) Assignee: International Business Machines Corporation, Armonk, NY (US)

(21) Appl. No.: 13/960,909

(22) Filed: Aug. 7, 2013

(51) Int. Cl. G06Q 30/02; G06Q 50/00

(52) U.S. Cl. CPC G06Q 30/0202; G06Q 50/01
USPC 705/7.31

(57) ABSTRACT

A method for identifying influence on user interest for products and ability of users and products to be influenced is disclosed. A processor identifies a degree of influence a number of influencers has over user interest for each of a number of products based on a history of user interest of a number of users for the number of products, wherein each influencer in the number of influencers as one of a user in the number of users and a product in the number of products. The processor also identifies a degree of ability of one or more of the number of users and the number of products to be influenced based on the degree of influence of each of the number of influencers and a number of relationships between the one or more of the number of users and the number of products and the number of influencers.

### BACKGROUND OF THE INVENTION

1. Field of the Invention

The disclosure relates generally to an improved data processing system, and, in particular, to processing information related to user interest in purchasing products. Still more particularly the present disclosure relates to a method and apparatus for computing an ability of user interest in products to be influenced.

2. Description of the Related Art

Today there are many types of social interaction through which social influence on product sales can be seen. For example, posting likes and dislikes on social networks about a product can have a large influence on the sales of some products and less influence on other products. In the context of marketing, there is interest in identifying when sales of products are strongly influenced through social interaction. There is also interest in identifying individuals that strongly influence the shopping behavior of others, especially with regard to particular products and product categories.

Identifying the social influencers and the types of social interactions that affect sales of a product can allow for improvements in marketing campaigns. For example, selecting which type of marketing campaign will work best for a particular category of products and which target audience to focus the marketing campaign on.

Therefore, it would be desirable to have a method, apparatus, and computer program product that takes into account at least some of the issues discussed above.

### SUMMARY

In one illustrative embodiment, a method, apparatus, and computer program product for identifying influence on user interest for products and ability of users and products to be influenced is disclosed. An apparatus identifies a degree of influence a number of influencers has over user interest for each of a number of products based on a history of user interest of a number of users for the number of products, wherein each influencer in the number of influencers as one of a user in the number of users and a product in the number of products. The apparatus retrieves a number of relationships between one or more of the number of users and the number of products and the number of influencers. The apparatus then identifies a degree of ability of the one or more of the number of users and the number of products to be influenced based on the degree of influence of each of the number of influencers and the number of relationships.

### BRIEF DESCRIPTION OF THE DRAWINGS

FIG. 1 is a block diagram of a data flow of a process for identifying influence on user interest for products in a social influenceability determination environment in accordance with an illustrative embodiment;

FIG. 2 is a block diagram of components in a data processing system involved in identifying influence on user interest for products in accordance with an illustrative embodiment;

FIG. 3 is a flow chart of a process for identifying influence on user interest for products in accordance with an illustrative embodiment;

FIG. 4 is a flow chart of a process for identifying influence on user interest for products and reporting a metric of product influenceability in accordance with an illustrative embodiment;

FIG. 5 is a flow chart of a process for calculating, for each of a number of users and each of a number of products, social influenceability and influence on purchases of the number of products in accordance with an illustrative embodiment; and

FIG. 6 is an illustration of a data processing system in accordance with an illustrative embodiment.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on remote computers or entirely on the remote computers. In the latter scenario, the remote computers may be connected to the user's computer through any type of network, including a local area network (LAN) or a wide area network (WAN), or the connection may be made to an external computer. Further in this latter scenario, the remote computers may include social network finders, product influence causality finders, and social influenceability finders in a social influenceability determination environment. For example, the social network finders, product influence causality finders, and social influenceability finders may be network appliances and other types of data processing systems that analyze data in the social influenceability determination environment.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The different illustrative embodiments provide a method, apparatus, and computer program product for identifying influence on user interest for products. For example, the different illustrative embodiments may use a process for identifying influence on user interest for products. For example, a product influence causality finder may identify a degree of influence each of a number of users and each of a number of products has over user interest for each of the number of products based on a history of user interest of the number of users for the number of products. A social network finder may identify a number of relationships comprising one or more of relationships between two or more users in the number of users, relationships between users and products for the number of users and the number of products, and relationships between two or more products in the number of products. A social influenceability finder may then identify a degree of ability of each of the number of users and of each of the number of products to be influenced by one or more other users in the number of users and by one or more other products in the number of products based on the degree of influence of each of the number of users, the degree of influence of each of the number of products, and the number of relationships.

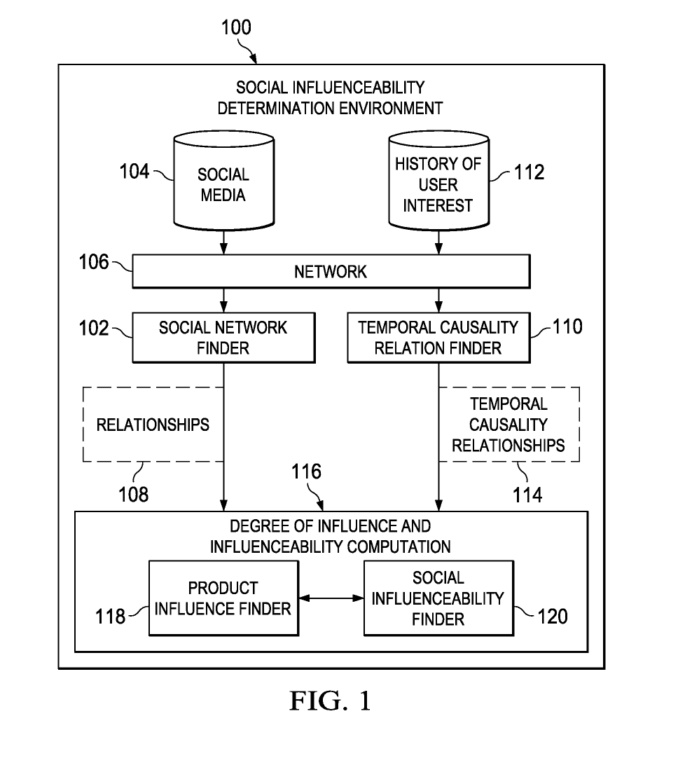

With reference now to the figures and, in particular, with reference to FIG. 1, a block diagram of a data flow of a process for identifying influence on user interest for products in a social influenceability determination environment is depicted in accordance with an illustrative embodiment. Social influenceability determination environment 100 is an example of an environment for computing social influenceability.

As used herein, “influenceability” of an item is an ability of user interest in the item to be influenced. As used herein, “social influenceability” of a product is an ability of user interest in the product to be influenced by associated relationships. In these illustrative examples, “relationships” associated with social influenceability include relationships between two or more users in the number of users, relationships between users and products for the number of users and the number of products, and relationships between two or more products in the number of products. For example, a product having a high level of social influenceability may be characterized by sales of the product depending on communities of users spreading information about the product within the community. In this example, social influence between users linked by a relationship is stronger than social influence between users that are not linked by a relationship. In this example, viral marketing is effective for the product because social recommendations are likely to have an influence on user interest for the product.

Examples of products having a high level of social influenceability may include multiplayer games, vacation packages, and many other socially influenced products. In these examples, positive sentiment encourages purchases and negative sentiment discourages purchases. Sentiment can be provided over voice communications, chat and instant messaging products, social networking sites, and many other forms of electronic communication.

By contrast to a high level of social influenceability, a low social influenceability of a product means that community interaction, social recommendations, and social influence campaigns will have a low impact on product sales. Examples of products that may have a low social influenceability include specially designed products such as designer women's apparel. In this example, if a person has the particular product, friends in a social circle of the person may not want to have the product or otherwise they would be seen as copying the person which may be seen as a bad thing to do within the social circle. Products that may have a low level of social influenceability also include products that are basic essentials that everybody buys irrespective of social interactions, such as groceries. Other products that may have a low level of social influenceability include products with stiff/inflexible demand. Products with a stiff/inflexible demand include products that are mandated to be purchased, such as uniforms, tools of a trade and the like. Still other products with a stiff/inflexible demand include products that people may repetitively purchase based on a history of purchases. Another example of products that may have a low level of social influenceability includes products for which most people have already tried each of the different brands and have already chosen what brand is their favorite. For example, the different brands of soda products may have a low level of social influenceability based on individuals having already chosen their favorite brand. In this example, even though the products can be popular in particular social circles, community interactions may have a low impact on product sales when the people in the social circles have already chosen their favorite brand.

As depicted, social network finder 102 is a component of social influenceability determination environment 100 for identifying number of relationships 108 in social media 104. In these illustrative examples, number of relationships 108 comprises one or more of relationships between two or more users in the number of users, relationships between users and products for the number of users and the number of products, and relationships between two or more products in the number of products. As depicted, social network finder 102 accesses social media 104 over network 106. In the illustrated examples, social media 104 may comprise magazines, Internet forums, weblogs, social blogs, micro blogs, wikis, social networks, podcasts, ratings, social bookmarks, email, instant messages, crowdsourcing information, voice over IP data, and any other suitable type of social media for social influenceability determination environment 100.

Temporal causality relation finder 110 is a component of social influenceability determination environment 100 for identifying number of temporal causality relationships 114 in history of user interest 112. As depicted, temporal causality relation finder 110 accesses history of user interest 112 over network 106. History of user interest 112 may be a database, memory, and any other suitable type of repository of information about user interest in social influenceability determination environment 100.

In these illustrative examples, history of user interest 112 comprises events associated with product purchases by a user, expressions of interest and opinion about particular products made by the user, and other suitable type of event information for identifying user interest in product in social influenceability determination environment 100. For example, the expressions of interest and opinion about particular products made by the user may include a number of times messages are viewed that are associated with the particular products and a number of messages created by the user that are associated with the particular products. For example, the viewed and created messages may be Tweets™, instant messages, e-mail, postings, and any other suitable type of message. For example, the viewed and created tweets may be associated with the particular products by referring to the products, specifying a rating for the products, specifying a like or dislike of the products, providing a review of the products, and by including statements associated with purchases of the products, and any other suitable expressions of interest for the products.

In these illustrative examples, number of temporal causality relationships 114 comprises one or more of relationships between two or more users in the number of users, relationships between users and products for the number of users and the number of products, and relationships between two or more products in the number of products. As used herein, a temporal causality relationship is a relationship that is based on cause and effect of events. For example, a first event may be identified as a cause of a second event that is identified as an effect of the first event. For example, temporal causality relation finder 110 may identify from history of user interest 112 that a temporal causality relationship exists between a first user and a second user. For example, temporal causality relation finder 110 may identify that when the first user buys a particular product the second user also buys the product.

Degree of influence and influenceability computation 116 is a group of components of social influenceability determination environment 100 for identifying influence on user interest. Product influence finder 118 is a component in degree of influence and influenceability computation 116 components for identifying a degree of influence a number of influencers have over user interest for products. In these illustrative examples, an influencer is one of a user and a product. In these illustrative examples, product influence finder 118 identifies the degree of influence that the number of influencers have over user interest for products based, in part, on associated relationships in relationships 108 and temporal causality relationships 114.

As depicted, social influenceability finder 120 is a component in degree of influence and influenceability computation 116 components for identifying an ability of user interest in products to be influenced by associated relationships. In these illustrative examples, social influenceability finder 120 may identify a degree of ability of each of a number of users and of each of a number of products to be influenced by a number of influencers based on a degree of influence of the influencers and associated relationships in relationships 108 and temporal causality relationships 114.

The illustration of social influenceability determination environment 100 in FIG. 1 is not meant to imply physical or architectural limitations to the manner in which different illustrative embodiments may be implemented. Other components in addition to and/or in place of the ones illustrated may be used. Some components may be unnecessary. Also, the blocks are presented to illustrate some functional components. One or more of these blocks may be combined and/or divided into different blocks when implemented in an illustrative embodiment.

For example, in some illustrative examples, additional social media and additional history of user interest in addition to social media 104 and history of user interest 112 may be present within social influenceability determination environment 100. Also, although social network finder 102 and temporal causality relation finder 110 are shown as separate blocks in social influenceability determination environment 100, all or a portion of social network finder 102 and temporal causality relation finder 110 may also be implemented in social influenceability finder 120 in social influenceability determination environment 100. In these illustrative examples, social influenceability determination environment 100 may be implemented by any combination of hardware and software products, and may also be implemented in one or more computer systems of a cluster of computer systems.

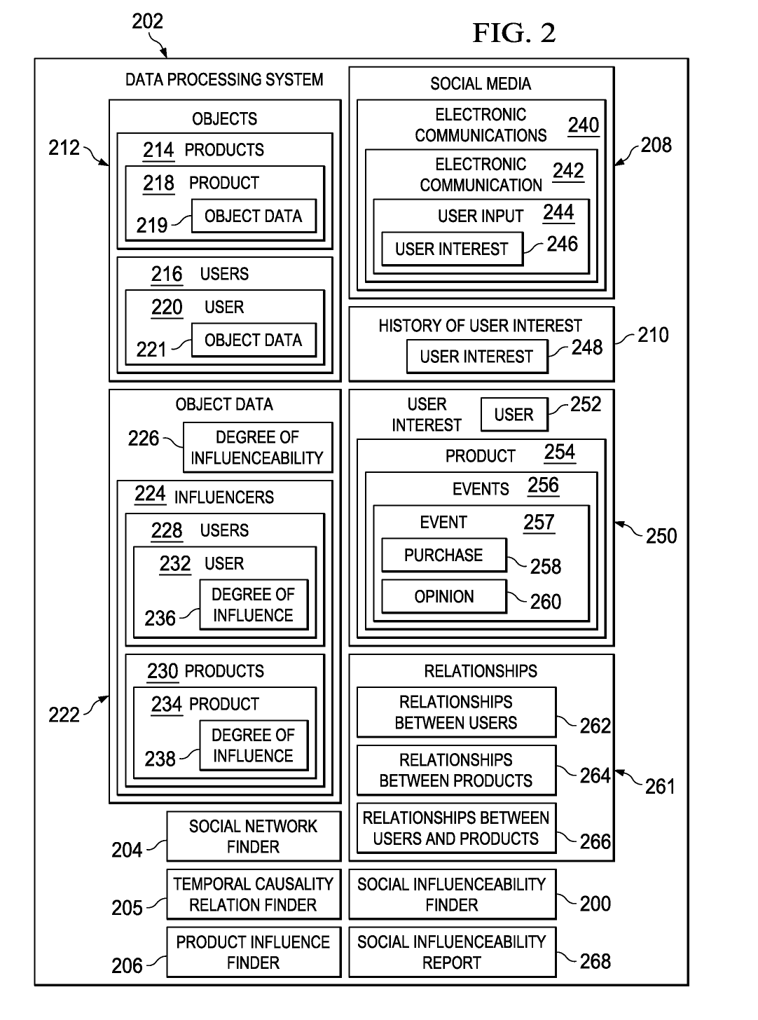

Turning now to FIG. 2, a block diagram of components in a data processing system involved in identifying influence on user interest for products is depicted in accordance with an illustrative embodiment. In these illustrative examples, social influenceability finder 200 in data processing system 202 is an example of one implementation of social influenceability finder 120 in FIG. 1. Social network finder 204 is an example of one implementation of social network finder 102 in FIG. 1, temporal causality relation finder 205, is an example of one implementation of temporal causality relation finder 110, and product influence finder 206 is an example of one implementation of product influence finder 118 in FIG. 1. Social media 208 is an example of one implementation of social media 104 in FIG. 1 and history of user interest 210 is an example of one implementation of history of user interest 112 in FIG. 1.

As depicted, number of objects 212 includes number of products 214 and number of users 216. In these illustrated examples, product 218 is an example of number of products 214 and user 220 is an example of users 216. Object data 222 is an example of object data 219 for product 218 and object data 221 for user 220. As depicted, object data 222 comprises influencers 224 and degree of influenceability 226. Influencers 224 in object data 222 comprise users 228 and products 230. User 232 is an example of a user in users 228 and product 234 is an example of a product in products 230. In these illustrative examples, degree of influence 236 of user 232 is a degree of influence user 232 has on an object in objects 212, such as product 218 and user 220. Degree of influence 238 of product 234 is a degree of influence product 234 has on an object in objects 212, such as product 218 and user 220.

In these illustrative examples, social media 208 comprises electronic communications 240. Electronic communication 242 is an example of an electronic communication in social media 208. As depicted, electronic communications 240 in social media 208 comprise user input 244 provided by one or more of users in users 216 and users 228. User interest 250 is an example of user interest 246 in social media 208 and is also an example of user interest 248 in history of user interest 210. In these illustrative examples, user interest 250 is a record of interest in product 254 by user 252. As depicted, user interest 250 for product 254 may include a record of number of events 256, such as event 257. In these illustrative examples, each event in events 256 may include information about a purchase of product 254 by user 252, such as purchase 258. Each event in events 256 may also include information about an opinion of product 254 by user 252, such as opinion 260.

Social network finder 204 identifies number of relationships 261 in data processing system 202 in a process for identifying influence on user interest for products. Number of relationships 261 includes number of relationships between users 262, number of relationships between products 264, and number of relationships between users and products 266.

For example, social influenceability finder 200 may calculate influence on user interest for products by first creating a graph G=(V,E) where the edges are all directed. In this example, V is the set of users 216. V may be written in the form V={v₁, v₂ . . . vₙ} where v₁, v₂ . . . vₙ are unique users, such as user 220. In this example, E is a set of connections between unique users in users 216, such as relationships between users 262. For example, connections between users may correspond to friendship relationship in social networks, or to social interactions between users, such as sharing a piece of information between users, and similar. In this one illustrative example, social influenceability finder 200 then creates adjacency matrix A for the set of users V that is used as a starting point. Each entry ₐᵢⱼ in adjacency matrix A is set to 1 if ᵥⱼ is connected to ᵥᵢ and set to 0 if ᵥⱼ is not connected to ᵥᵢ. In this example, social influenceability finder 200 creates vector Aⱼ as the vector of neighbors for user vⱼ, such that the i^{th} element Aⱼ(i) is set to 1 if vᵢ is connected to vⱼ, and set to 0 otherwise. In this process, P is the set of products 214. P may be written in the form P={p1, p2 . . . pₘ} where p1, p2 . . . pₘ are unique products, such as product 218. In this example, product 218 may be written in the form pᵢ. Social influenceability finder 200 then creates ordered list Pᵢ of users who bought product 218, in this example. Pᵢ, in this example, is an ordered list of the users who bought pᵢ in chronological order, in this process. The expression Pi=[v₁, v₂] means that user v₁ is the first user that bought pᵢ and v₂ is the second user who bought pᵢ. In this example, social influenceability finder 200 next creates vector Pᵢ(j) as the vector of users who bought product pᵢ after user vⱼ. In this example, the k^{th} entry Pᵢ^{k}(j) is set to 1 by the process if user vₖ purchases the item pᵢ after user vⱼ, and set to 0 by the process otherwise. The expression Aⱼ.Pᵢ(j)=ΣₖAⱼ(k)*Pᵢ^{k}(j) represents the number of people who are connected to vⱼ and have purchased the item pᵢ after vⱼ (i.e., people who belong to both Aⱼ and Pᵢ(j)). In this example, social influenceability finder 200 then calculates influence of a product purchase Wᵢⱼ using the equation:

$${W}_{ij} = \frac{{A}_{j} \cdot {P}_{i} ( j )}{( \vert Aj \vert * \frac{\vert {P}_{i} ( j ) \vert}{\vert V \vert} )}$$

In this example, |X| means the number of non-zero elements of vector X. The numerator of this equation is the number of people who have purchased the product pᵢ after user vⱼ. The denominator of this equation is the number of people who are expected to purchase the product pᵢ and be connected to user vⱼ. The total population, is |V|. The expression |Pᵢ(j)| is the people who have purchased the product pᵢ after user vⱼ. The ratio of people who have purchased the product pᵢ after user vⱼ to the entire population is (|Pᵢ(j)|/|V|)). In this example, social influenceability finder 200 may also take a person at random, and determine what the chance is that the person would purchase the product pᵢ after user vⱼ by using the ratio of ratio of people who have purchased the product pᵢ after user vⱼ to the entire population (|Pᵢ(j)|/|V|)). Because, vⱼ has |Aⱼ| neighbors, the expected number of people who are neighbors of vⱼ and have purchased the product pᵢ after user vⱼ is the number of neighbors of vⱼ multiplied by each neighbors chance of being a person who has purchased the product pᵢ after user vⱼ. The expected number of people who are neighbors of vⱼ and have purchased the product pᵢ after user vⱼ may be written in the form (|Aj|*(|Pᵢ(j)|/|V|)). In this example, social influenceability finder 200 determines whether social influence of users on products is uniform or non-uniform, by analyzing social influence for a number of users. Social influenceability finder 200 also determines whether influenceability of products is uniform or non-uniform, by analyzing the degree of influenceability on products by influencers. In this example, social influenceability finder 200 calculates, based on a determination of uniformity of influenceability of products, that the “influence” of user vⱼ is the average of the W score of user vⱼ over all the products pᵢ written in the form of the equation:

$$I ( j ) = \frac{{\sum }_{{p}_{i} ∈ P} {W}_{ij}}{\vert P \vert}$$

In this example, social influenceability finder 200 also calculates, based on a determination of uniformity of social influence of users, that the influenceability of a product pᵢ is the average of the W score of the pᵢ over all the users vⱼ written in the form of the equation:

$$S ( i ) = \frac{{\sum }_{{v}_{j} ∈ V} {W}_{ij}}{\vert V \vert}$$

In this example, social influenceability finder 200 further calculates, based on a determination of non-uniformity of influenceability of products, that the influence of user v is:

$$I ( j ) = \frac{1}{{\sum }_{{p}_{i} ∈ P} S ( i )} {\sum }_{{p}_{i} ∈ P} S ( i ) * {W}_{ij}$$

In this example, social influenceability finder 200 still further calculates, based on a determination of non-uniformity of social influence of users, that the influenceability of product p is:

$$S ( i ) = \frac{1}{{\sum }_{{v}_{j} ∈ V} I ( j )} {\sum }_{{v}_{j} ∈ V} I ( j ) * {W}_{i} j$$

The formulas shown above for I(j) and S(j) present one possible way of formally expressing the underlying concepts of social influenceability and social influence. Variations of the formulas can also be used. For example, the above formulas consider direct neighbors Aⱼ of user vⱼ. Alternatively, it may be beneficial to consider all users who are transitively connected with user vⱼ. Similarly, the formulas can be expressed in the standard matrix notation. For example, I(j) can be expressed as I=W^{T}*W*I where W^{T} is transpose matrix of W and * is the matrix multiplication), where |S|=Σ(Si). As another example, S(i) can be expressed in matrix notation as S=W*W^{T}*S where W^{T} is transpose matrix of W, * is the matrix multiplication, and |I|=Σ(Ij). In these illustrative examples, the formulas may be used for computing the social influenceability and social influence.

As depicted, social influenceability finder 200 generates social influenceability report 268. For example, report 268 may comprise one or more of degree of influence 236 of number of users 228, degree of influence 238 of number of products 230, degree of influenceability 226 for each of number of products 214, and degree of influenceability 226 for each of number of users 216. Report 268 may also comprise one or more of all or a portion of relationships 261 and all or a portion of history of user interest 210.

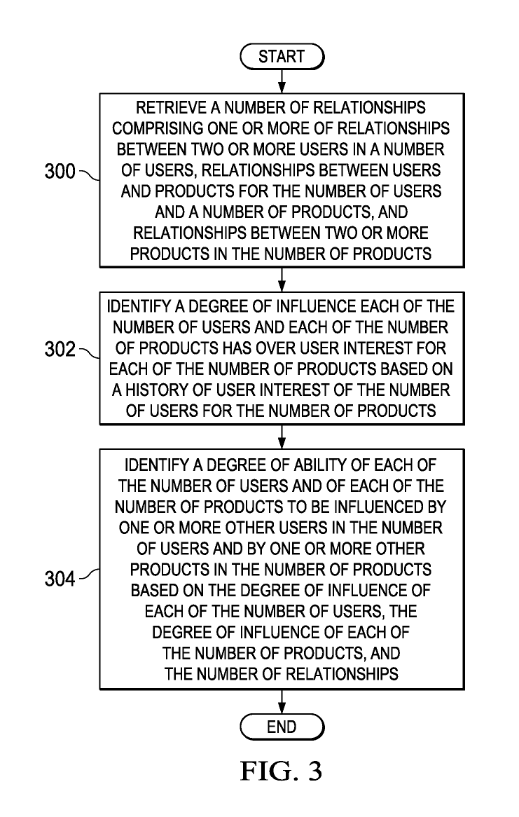

Turning next to FIG. 3, an illustrative example of a flowchart of a process for identifying influence on user interest for products is depicted in accordance with an illustrative embodiment. The steps in the process may be implemented in software, hardware, or a combination of the two by data processing system 202 in FIG. 2.

The process begins by retrieving a number of relationships comprising one or more of relationships between two or more users in a number of users, relationships between users and products for the number of users and a number of products, and relationships between two or more products in the number of products (step 300). In this illustrated process, the number of relationships is an example of relationships number of relationships 261 in FIG. 2.

The process identifies a degree of influence each of the number of users and each of the number of products has over user interest for each of the number of products based on a history of user interest of the number of users for the number of products (step 302). In this illustrated process, the degree of influence each of the number of users has over user interest is an example of degree of influence 236 in FIG. 2 for each of number of users 228 in FIG. 2. The degree of influence each of the number of products has over user interest is an example of degree of influence 238 in FIG. 2 for each of number of products 230 in FIG. 2. The history of user interest, in this illustrated process, is an example of history of user interest 210 in FIG. 2.

The process then identifies a degree of ability of each of the number of users and of each of the number of products to be influenced by one or more other users in the number of users and by one or more other products in the number of products based on the degree of influence of each of the number of users, the degree of influence of each of the number of products, and the number of relationships (step 304) with the process terminating thereafter. In this illustrated process, the degree of ability of each of the number of users and of each of the number of products to be influenced by one or more other users in the number of users and by one or more other products in the number of products is an example of degree of influenceability 226 in FIG. 2. It should also be noted that, although steps 302 and 304 are shown in succession, steps 302 and 304 may, in fact, be performed substantially concurrently and steps 302 and 304 may also be performed in the reverse order.

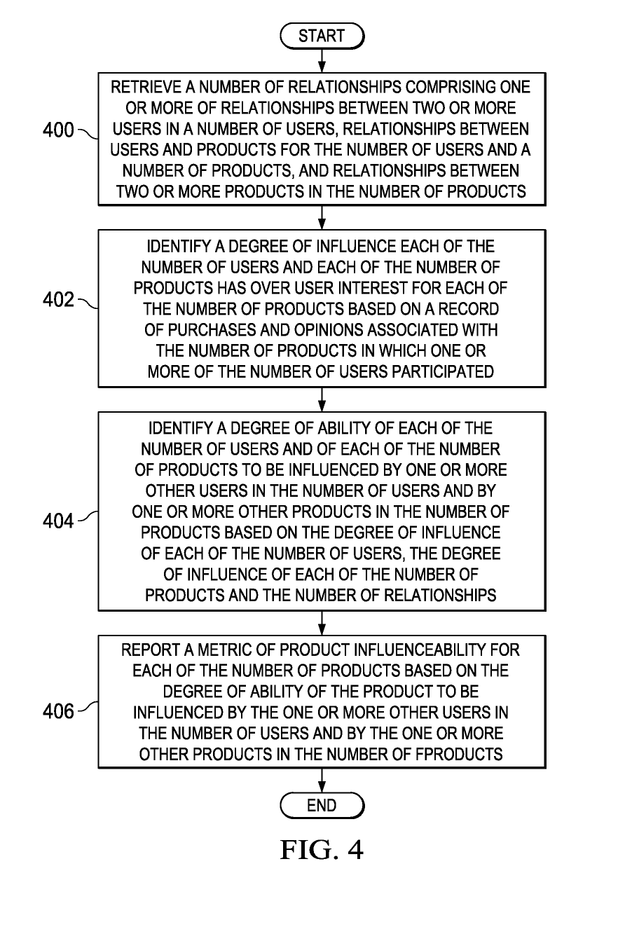

Turning next to FIG. 4, an illustrative example of a flowchart of a process for identifying influence on user interest for products and reporting a metric of product influenceability is depicted in accordance with an illustrative embodiment. The steps in the process may be implemented in software, hardware, or a combination of the two by data processing system 202 in FIG. 2.

The process begins by retrieving a number of relationships comprising one or more of relationships between two or more users in a number of users, relationships between users and products for the number of users and a number of products, and relationships between two or more products in the number of products (step 400). In this illustrated process, the number of relationships is an example of number of relationships 261 in FIG. 2.

The process identifies a degree of influence each of the number of users and each of the number of products has over user interest for each of the number of products based on a record of purchases and opinions associated with the number of products in which one or more of the number of users participated (step 402). In this illustrated process, the degree of influence each of the number of users has over user interest is an example of degree of influence 236 in FIG. 2 for each of number of users 228 in FIG. 2. The degree of influence each of the number of products has over user interest is an example of degree of influence 238 in FIG. 2 for each of number of products 230 in FIG. 2. The record of purchases and opinions associated with the number of products in which one or more of the number of users participated, is an example of user interest 248 in history of user interest 210 in FIG. 2 and user interest 246 in user input 244 in electronic communications 240 of social media 208 in FIG. 2.

The process next identifies a degree of ability of each of the number of users and of each of the number of products to be influenced by one or more other users in the number of users and by one or more other products in the number of products based on the degree of influence of each of the number of users, the degree of influence of each of the number of products, and the number of relationships (step 404). In this illustrated process, the degree of ability of each of the number of users and of each of the number of products to be influenced by one or more other users in the number of users and by one or more other products in the number of products is an example of degree of influenceability 226 in FIG. 2.

The process then reports a metric of product influenceability for each of the number of products based on the degree of ability of the product to be influenced by the one or more other users in the number of users and by the one or more other products in the number of products (step 406) with the process terminating thereafter. It should also be noted that, although steps 402 and 404 are shown in succession, steps 402 and 404 may, in fact, be performed substantially concurrently and steps 402 and 404 may also be performed in the reverse order.

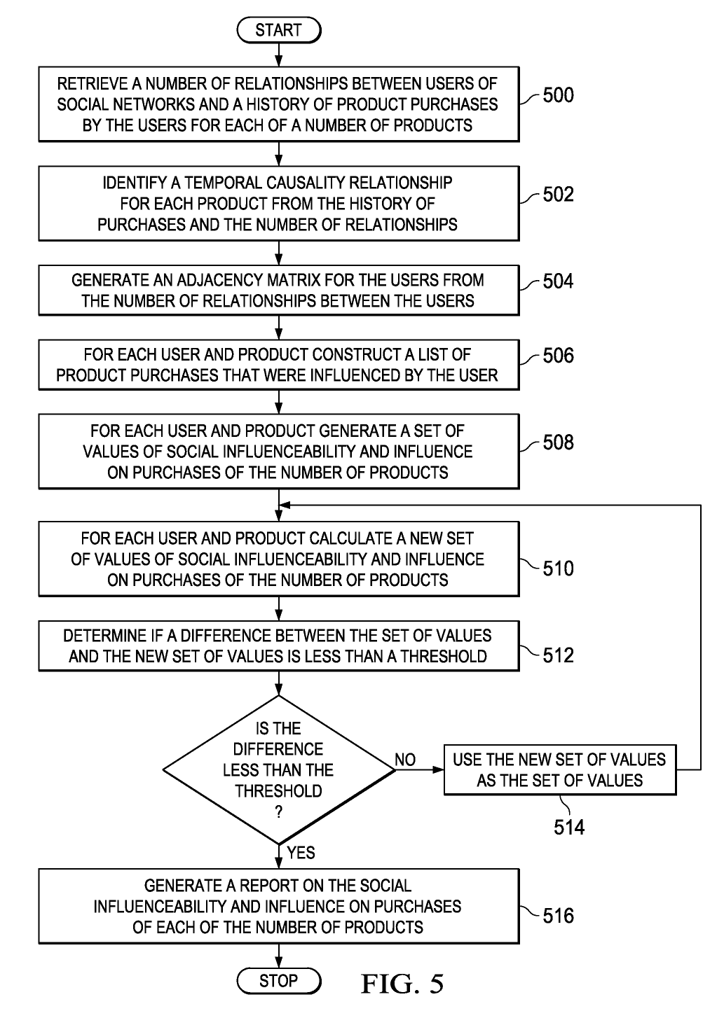

Turning next to FIG. 5, an illustrative example of a flowchart of a process for calculating, for each of a number of users and each of a number of products, social influenceability and influence on purchases of the number of products is depicted in accordance with an illustrative embodiment. The steps in the process may be implemented in software, hardware, or a combination of the two by data processing system 202 in FIG. 2.

The process begins by retrieving a number of relationships between users of social networks and retrieving a history of product purchases by the users for each of a number of products (step 500). In this illustrated process, the number of relationships between users is an example of number of relationships between users 262 in FIG. 2 and the history of product purchases is an example of history of user interest 210 in FIG. 2.

The process identifies a temporal causality relationship for each product from the history of purchases and the number of relationships (step 502). The process generates an adjacency matrix for the users from the number of relationships between the users (step 504). The process also constructs, for each user and product, a list of product purchases that were influenced by the user (step 506). The process further generates, for each user and product, a set of values of social influenceability and influence on purchases of the number of products (step 508). In this illustrated process, the set of values of social influenceability is an example of degree of influenceability 226 for products 214 in FIG. 2 and degree of influenceability 226 for users 216 in FIG. 2.

As depicted, the process calculates, for each user and product, a new set of values of social influenceability and influence on purchases of the number of products (step 510). The process then determines if a difference between the set of values and the new set of values is less than a threshold (step 512). In this illustrated process, if the difference is not less than the threshold the process uses the new set of values as the set of values (step 514) with the process returning to step 510. As depicted, if the difference is less than the threshold the process generates a report on the social influenceability and influence on purchases of each of the number of products (step 516) with the process terminating thereafter. In this illustrated process, the report on the social influenceability and influence on purchases of each of the number of products is an example of social influenceability report 268 in FIG. 2.

The process for calculating, for each of a number of users and each of a number of products, social influenceability and influence on purchases of the number of products may also use the formulas described above for S(j) and I(j), and may also use matrix techniques based on an Eigen value equation form of the S(j) and I(j) formulas.

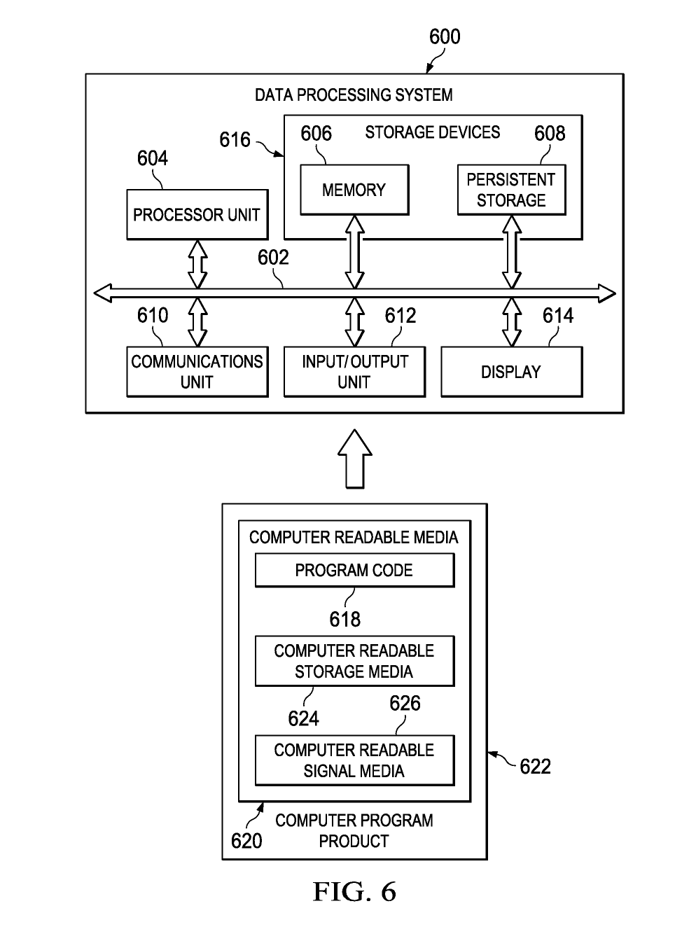

Turning now to FIG. 6, an illustration of a data processing system is depicted in accordance with an illustrative embodiment. Data processing system 600 is an example of a data processing system that may be used to identify influence on user interest for products. More particularly, data processing system 600 may be used to implement data processing system 202 in FIG. 2. In this illustrative example, data processing system 600 includes communications framework 602, which provides communications between processor unit 604, memory 606, persistent storage 608, communications unit 610, input/output (I/O) unit 612, and display 614. In these examples, communications frame work 602 may be a bus system.

Processor unit 604 serves to execute instructions for software that may be loaded into memory 606. Processor unit 604 may be a number of processors, a multi-processor core, or some other type of processor, depending on the particular implementation. A number, as used herein with reference to an item, means one or more items. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device is any piece of hardware that is capable of storing information, such as, for example, without limitation, data, program code in functional form, and/or other suitable information either on a temporary basis and/or a permanent basis. Storage devices 616 may also be referred to as computer readable storage devices in these examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these examples, provides for communications with other data processing systems or devices. In these examples, communications unit 610 is a network interface card. Communications unit 610 may provide communications through the use of either or both physical and wireless communications links.

Input/output unit 612 allows for input and output of data with other devices that may be connected to data processing system 600. For example, input/output unit 612 may provide a connection for user input through a keyboard, a mouse, and/or some other suitable input device. Further, input/output unit 612 may send output to a printer. Display 614 provides a mechanism to display information to a user.

Instructions for the operating system, applications, and/or programs may be located in storage devices 616, which are in communication with processor unit 604 through communications framework 602. In these illustrative examples, the instructions are in a functional form on persistent storage 608. These instructions may be loaded into memory 606 for execution by processor unit 604. The processes of the different embodiments may be performed by processor unit 604 using computer implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these examples. In one example, computer readable media 620 may be computer readable storage media 624 or computer readable signal media 626. Computer readable storage media 624 may include, for example, an optical or magnetic disk that is inserted or placed into a drive or other device that is part of persistent storage 608 for transfer onto a storage device, such as a hard drive, that is part of persistent storage 608. Computer readable storage media 624 also may take the form of a persistent storage, such as a hard drive, a thumb drive, or a flash memory, that is connected to data processing system 600. In some instances, computer readable storage media 624 may not be removable from data processing system 600. In these examples, computer readable storage media 624 is a physical or tangible storage device used to store program code 618 rather than a medium that propagates or transmits program code 618. Computer readable storage media 624 is also referred to as a computer readable tangible storage device or a computer readable physical storage device. In other words, computer readable storage media 624 is a media that can be touched by a person.

Alternatively, program code 618 may be transferred to data processing system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer readable signal media 626 for use within data processing system 600. For instance, program code stored in a computer readable storage medium in a server data processing system may be downloaded over a network from the server to data processing system 600. The data processing system providing program code 618 may be a server computer, a client computer, or some other device capable of storing and transmitting program code 618.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 604 may take the form of a hardware unit that has circuits that are manufactured or configured for a particular use. This type of hardware may perform operations without needing program code to be loaded into a memory from a storage device to be configured to perform the operations. For example, when processor unit 604 takes the form of a hardware unit, processor unit 604 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 618 may be omitted because the processes for the different embodiments are implemented in a hardware unit.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, a bus system may be used to implement communications framework 602 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 606, or a cache, such as found in an interface and memory controller hub that may be present in communications framework 602.

Thus, the illustrative embodiments provide a method, apparatus, and computer program product for identifying influence on user interest for products. In one example, a program identifies a degree of influence each of a number of users and each of a number of products has over user interest for each of the number of products based on a history of user interest of the number of users for the number of products. In this example, the program identifies a number of relationships comprising one or more of relationships between two or more users in the number of users, relationships between users and products for the number of users and the number of products, and relationships between two or more products in the number of products. The program then identifies a degree of ability of each of the number of users and of each of the number of products to be influenced by one or more other users in the number of users and by one or more other products in the number of products based on the degree of influence of each of the number of users, the degree of influence of each of the number of products, and the number of relationships.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. As used herein, the phrase “at least one of”, when used with a list of items, means that different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C. In other examples, “at least one of” may be, for example, without limitation, two of item A, one of item B, and ten of item C; four of item B and seven of item C; and other suitable combinations.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for identifying influence on user interest for products, the method comprising:
identifying, by one or more processors, a degree of influence a number of influencers has over user interest for each of a number of products based on a history of user interest of a number of users for the number of products, wherein each influencer in the number of influencers is one of a user in the number of users and a product in the number of products; and
identifying, by one or more processors, a degree of ability of one or more of the number of users and the number of products to be influenced based on the degree of influence of each of the number of influencers and a number of relationships between the one or more of the number of users and the number of products and the number of influencers.

2. The method of claim 1, wherein the history of user interest of the number of users for the number of products includes a record of events associated with the number of products in which one or more of the number of users participated.

3. The method of claim 1, wherein the history of user interest of the number of users for the number of products includes expressed interest provided by user input in one or more electronic communications of the number of users.

4. The method of claim 3, wherein the one or more electronic communications of the number of users comprise electronic communications of one or more social networks.

5. The method of claim 2, wherein the record of events associated with the number of products includes purchases of the products by the number of users, and further comprising:
reporting the degree of ability of a product to be influenced by the number of influencers as an amount of influence the history of user interest and the number of relationships have on purchases of the product.

6. The method of claim 5, wherein reporting the degree of ability of the product to be influenced by the number of influencers as the amount of influence the history of user interest and the number of relationships have on purchases of the product comprises:
reporting whether purchase of a product is likely based on a number of times a user performs actions expressing interest in the product in the history of user interest, the actions comprising one or more of viewing a tweet associated with the product and creating a tweet that expresses interest in the product.

7. The method of claim 5, wherein the ability of each user to be influenced by the number of influencers is based on influence exerted by the history of user interest of the number of users and the number of relationships on purchases of the products by each respective user.

8. The method of claim 1, wherein the history of user interest includes actions taken by the number of users associated with the number of relationships, and wherein the actions taken by the number of users identify influence of the number of relationships on the number of users.

9. The method of claim 8, wherein the actions taken by the number of users include, memberships in organizations associated with the history of user interest, listing as a user of a product in the number of products, and providing user input comprising one of opinions and suggestions in phone conversations, email, chats, (re-)postings, (re-)tweets, and blogs.

10. The method of claim 1, wherein the degree of influence and the degree of ability to be influenced is determined by one or more of an analysis of buying patterns, a connection on a social network, a strength of a connection on a social network, a number of telephone communications, common interests, a number of communications about a common interest, and a hierarchical relationship in a domain, the domain comprising one or more of student and teacher relationships in an education environment, manager and worker relationships in a workplace environment, and expert and novice relationships associated with one or more of the number of products.

11. The method of claim 1, wherein the degree of influence and the degree of ability to be influenced are identified with respect to a random degree of influence.

12. An apparatus for identifying influence on user interest for products, the apparatus comprising:
one or more processor units and one or more memories;
first program code to identify a degree of influence a number of influencers has over user interest for each of a number of products based on a history of user interest of the number of users for the number of products, wherein each influencer in the number of influencers is one of a user in the number of users and a product in the number of products; and
second program code to identify a degree of ability of one or more of the number of users and the number of products to be influenced based on the degree of influence of each of the number of influencers and a number of relationships between the one or more of the number of users and the number of products and the number of influencers.

13. The apparatus of claim 12, wherein the history of user interest of the number of users for the number of products includes a record of events associated with the number of products in which one or more of the number of users participated.

14. The apparatus of claim 12, wherein the history of user interest of the number of users for the number of products includes expressed interest provided by user input in one or more electronic communications of the number of users.

15. The apparatus of claim 14, wherein the one or more electronic communications of the number of users comprise electronic communications of one or more social networks.

16. The apparatus of claim 13, wherein the record of events associated with the number of products includes purchases of the products by the number of users, and further comprising:
third program code to report the degree of ability of a product to be influenced by the number of influencers as an amount of influence the history of user interest and the number of relationships have on purchases of the product, wherein the third program code is stored in at least one of the one or more memories for execution by at least one of the one or more processor units via at least one of the one or more memories.

17. The apparatus of claim 16, wherein third program code to report the degree of ability of the product to be influenced by the number of influencers as the amount of influence the history of user interest and the number of relationships have on purchases of the product comprises:
program instructions to report whether purchase of a product is likely based on a number of times a user performs actions expressing interest in the product in the history of user interest, the actions comprising one or more of viewing a tweet associated with the product and creating a tweet that expresses interest in the product.

18. The apparatus of claim 16, wherein the ability of each user to be influenced by the number of influencers is based on influence exerted by the history of user interest of the number of users and the number of relationships on purchases of the products by each respective user.

19. A computer program product for identifying influence on user interest for products, the computer program product comprising program instructions stored on a computer readable storage device, for:
identifying a degree of influence a number of influencers has over user interest for each of a number of products based on a history of user interest of the number of users for the number of products, wherein each influencer in the number of influencers is one of a user in the number of users and a product in the number of products; and
identifying a degree of ability of one or more of the number of users and the number of products to be influenced based on the degree of influence of each of the number of influencers and a number of relationships between the one or more of the number of users and the number of products and the number of influencers.

20. The computer program product of claim 19, wherein the history of user interest of the number of users for the number of products includes at least one of a record of events associated with the number of products in which one or more of the number of users participated and expressed interest provided by user input in one or more electronic communications of the number of users.
